(19) United States
(12) Patent Application Publication
(10) Pub. No.: US 2025/0254593 A1
(43) Pub. Date: Aug. 7, 2025

(54) SYSTEMS AND METHODS FOR OPTIMIZING NETWORK TOPOLOGY BASED ON ACCESS POINT LOCALIZATION

(71) Applicant: PLUME DESIGN, INC., Palo Alto, CA (US)

(72) Inventors: Dariusz KOPKA, Warsaw (PL); Grigor RISTOV, Ljubljana (SI); Gal TRAPECAR, Ljubljana (SI); Metod MEDJA, Ljubljana (SI); Miroslav SAMARDZIJA, Mountain View, CA (US); Liem Hieu Dinh VO, San Jose, CA (US)

(21) Appl. No.: 18/434,929

(22) Filed: Feb. 7, 2024

(51) Int. Cl. H04W 36/32; H04W 36/08; H04W 64/00

(52) U.S. Cl. CPC H04W 36/324; H04W 36/08; H04W 64/003

(57) ABSTRACT

Disclosed are systems and methods for optimizing wireless network topology are disclosed, particularly for use in complex environments, such as Multi-Dwelling Units (MDUs). The disclosed framework provides uninterrupted wireless connectivity and an enhanced user experience by dynamically managing network connections and executing seamless handoffs between APs. The framework manages connections to wireless access points (APs) based on the physical layout of the environment and/or user behavior. The framework effectuates receiving data on the network's physical structure and AP locations, tracking client device movement, and predicting the client device's path to proactively manage network resources. The framework can reserve resources at APs along the predicted path and establish a virtual tunnel to facilitate seamless handoff between APs as the client device moves. Adjustments to the network resources and virtual tunnel are made in response to changes in the client device's movement, which includes skipping APs in some embodiments.

### FIELD OF THE DISCLOSURE

The present disclosure relates generally to network optimization, and more specifically, to a system and methods for optimizing network topology based on the locations of Wireless Fidelity (Wi-Fi) Access Points (APs) and/or determined user behavior.

### BACKGROUND

In conventional wireless communication networks, particularly within environments such as Multi-Dwelling Units (MDUs), maintaining a consistent and high-quality connection for client devices as they move throughout the coverage area is a significant challenge. As users with mobile devices, such as smartphones, tablets, and laptops, roam within a building or complex, they often experience service interruptions and degraded performance due to the need to switch between different wireless APs. These interruptions can result in dropped connections, slow data rates, and overall poor user experience.

Traditional wireless networks often rely on reactive measures to handle device handoffs from one AP to another, which can lead to delays and connection losses. The process of re-authentication and re-association with a new AP can be time-consuming, and the decision to hand off is typically based on signal strength thresholds, which do not always correlate with the optimal path of movement or network conditions.

Furthermore, the physical layout of MDUs, with numerous walls, floors, and varying room configurations, adds complexity to the task of predicting the movement of client devices and managing network resources effectively. The presence of multiple APs within close proximity can lead to interference and overlapping coverage areas, complicating the handoff process.

### SUMMARY OF THE DISCLOSURE

The increasing demand for seamless wireless connectivity and the proliferation of Internet of Things (IoT) devices further exacerbate the need for a more intelligent and proactive approach to network management. Users expect uninterrupted service for applications such as video streaming, online gaming, and voice over IP (VOIP) calls, which require consistent and reliable network performance.

To that end, the instant disclosure provides computerized mechanisms that can intelligently predict the movement of client devices, dynamically manage network resources, and execute seamless handoffs between APs. Such a system would not only improve the user experience, but also optimize the overall efficiency and capacity of wireless networks in complex environments like MDUs.

According to some embodiments, a method is disclosed for a DI-based computerized framework for deterministically predicting, controlling, and/or managing how/when a connection to an AP is initiated. The present disclosure outlines a method for improving wireless network connections in large, complex environments like apartment buildings or office complexes. The system executes a computer implemented method involving a series of steps that ensure that devices like smartphones, tablets, or laptops maintain a strong and stable connection to the network as they move around the building.

In accordance with some embodiments, the present disclosure provides one or more computers comprising one or more processors and one or more non-transitory computer-readable storage media for carrying out the above-mentioned technical steps of the framework's functionality. The non-transitory computer-readable storage medium has tangibly stored thereon, or tangibly encoded thereon, computer readable instructions that when executed by a device cause a processor to perform a method for controlling and/or managing how/when AP connections are made and/or transferred to a client device.

In some embodiments, the disclosed mechanisms involve gathering information about the layout of the building and the location of wireless access points (APs), which include devices that broadcast wireless signals. In some embodiments, the framework tracks the location and movement of the client devices. For example, if a person is moving around an apartment building with their smartphone, the framework stores a history of their location and movement for use in prediction analysis.

The framework uses sensed and/or stored information to predict where the client device will move next. For example, if the person with a smartphone is moving towards an elevator, the framework can predict that they are going to a different floor. Based on this prediction, the framework determines which access points the smartphone will likely connect to as it moves.

Once the framework has made these predictions, the framework is configured to prepare the network for the client device's movement. In some embodiments, a computer implemented step includes reserving network resources at the predicted access points and/or creating a virtual tunnel for the device's connection to move through, ensuring a smooth and uninterrupted connection.

In some embodiments, the framework continuously monitors the client device's movement and adjusts the network resources and virtual tunnel as needed. For example, if the person with the smartphone decides to stay on their current floor instead of going to a different floor, the framework would update its predictions and adjust the network resources and virtual tunnel accordingly.

Hence, the framework provides a proactive approach to managing wireless network connections in large, complex environments. By predicting the movement of client devices and dynamically managing network resources, the method aims to provide a smooth and uninterrupted connection for users as they move around the building.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an example multi-dwelling unit horizontal and vertical layout according to some embodiments of the present disclosure;

FIG. 4 illustrates an example execution workflow according to some embodiments of the present disclosure;

FIG. 5 depicts an example implementation of system architecture according to some embodiments of the present disclosure;

FIG. 6 depicts an example implementation of system architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended, where the metes and bounds of the system is defined using different combinations of embodiments and functionality. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

While the term “some embodiments” or similar language is used herein, they do not denote separate frameworks, but instead emphasize configurations of a single system configured to execute any embodiment described herein. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part, as they each describe functionality of the same system.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense: any singular or plural recitation of an element may be described as “one or more” when defining the metes and bounds of the system. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable, and/or non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN), or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. In some embodiments, one or more modules described herein may access functionality and/or programs stored on one or more remote computers and/or servers via a network connection.

For purposes of this disclosure, a “wireless network” should be understood to couple client devices (e.g., user equipment) with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2^{nd}, 3^{rd}, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, and/or using the virtual tunnels and/or servers described herein.

A computing device, which may include one or more computers, may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. The access points (APs) described herein may also be considered a server configured to execute one or more of the framework's program instructions.

For purposes of this disclosure, user equipment such as a client (or user, entity, subscriber, or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K, for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, the disclosed framework provides integrated control and management of one or more devices and/or the applications executing thereon.

By way of a non-limiting example, according to some embodiments, the framework is configured to manage and control how communication is established between one or more access points (APs) and a client device. According to some embodiments, as discussed infra, the framework can determine a network topography and/or geographical boundary based on AP signals.

APs broadcast wireless signals, and the strength of these signals can vary based on the distance from the AP. Areas with stronger signals indicate proximity to APs, while weaker signals may suggest greater distances. In some embodiments, by collecting signal strength measurements from multiple APs across the network, a signal strength map or coverage map can be created by the framework.

In some embodiments, triangulation and/or trilateration techniques employed by the framework involve using the signal strength information from multiple APs to estimate the location of a device. Triangulation uses the angles formed by the signals, while trilateration relies on the distances between the device and multiple APs. By applying these principles to a network of APs, the overall topography and layout of the network can be inferred by the framework.

In some embodiments, the framework uses fingerprinting to create a database of signal characteristics (such as signal strength, modulation, and channel information) at known locations within the network. As a device moves through the network, its current location can be estimated by comparing its received signal characteristics with the fingerprint database. This technique contributes to understanding the spatial distribution of APs by the framework.

In some embodiments, the framework includes GIS tools that integrate information from APs with geographical maps, providing a visual representation of the network's layout and coverage. GIS tools allow for the creation of maps that illustrate signal strength variations, coverage areas, and potential dead zones within the network.

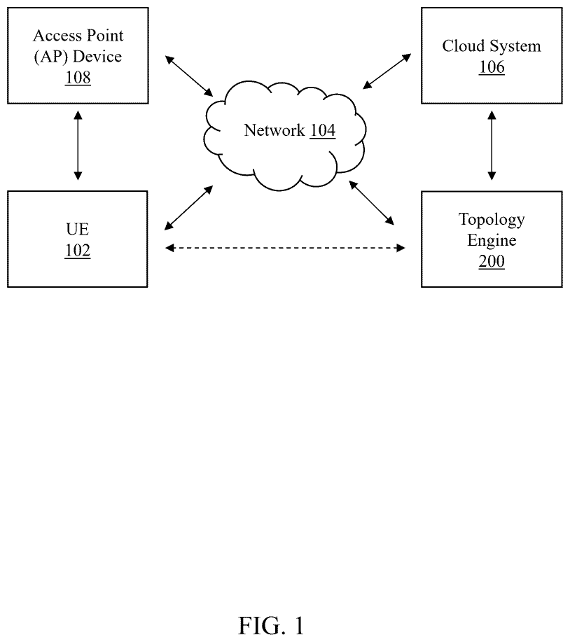

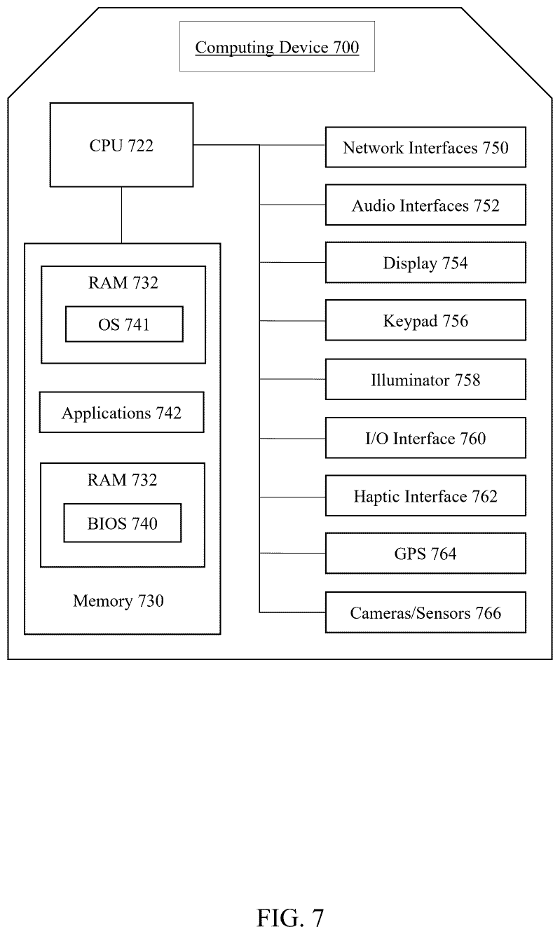

With reference to FIG. 1, system 100 is depicted which includes user equipment (UE) 102 (e.g., a client device, as mentioned above and discussed below in relation to FIG. 7), network 104, cloud system 106, access point (AP) device 108, and topology engine 200. It should be understood that while system 100 is depicted as including such components, it should not be construed as limiting, as one of ordinary skill in the art would readily understand that varying numbers of UEs, AP devices, peripheral devices, cloud systems, databases and networks can be utilized; however, for purposes of explanation, system 100 is discussed in relation to the example depiction in FIG. 1.

According to some embodiments, UE 102 can be any type of device, such as, but not limited to, a mobile (smart) phone, (smart) watch, tablet, laptop, sensor, IoT device, autonomous machine, appliance, and/or any other device equipped with a cellular and/or wireless or wired transceiver. For example, UE 102 can be a smart phone with various Apps installed, which as discussed below in more detail, can enable the identification and/or collection of activity information of the user to guide actual App and/or UE usage.

In some embodiments, one or more peripheral devices (not shown) can be connected to UE 102, and can be any type of peripheral device, such as, but not limited to, a wearable device, printer, speaker, sensor, and the like. In some embodiments, peripheral device can be any type of device that is connectable to UE 102 via any type of known or to be known pairing mechanism, including, but not limited to, Wi-Fi, Bluetooth™, Bluetooth Low Energy™ (BLE), NFC, and the like. For example, the peripheral device can be a smart watch that connectively pairs with UE 102, which is a user's smart phone in some non-limiting examples. In some embodiments, UE 102 includes a peripheral device, such as a smart watch, where the peripheral device is able to connect to AP device 108 directly without the use of a smart phone. In some embodiments, where the peripheral device uses the smart phone's network, the peripheral device is the UE and the smart phone is the AP.

According to some embodiments, AP device 108 is a device that creates a wireless local area network (WLAN) for the location. According to some embodiments, the AP device 108 can be, but is not limited to, a router, switch, hub and/or any other type of network hardware that can project a Wi-Fi signal to a designated area. In some embodiments, UE 102 may include an AP device, an example of which would be a mobile hotspot broadcast from a smart phone.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network-based system upon which applications, operations, and/or other forms of network resources may be located. For example, cloud system 106 may be a service provider and/or network provider from where services and/or applications may be accessed, sourced or executed from. For example, cloud system 106 can represent the cloud-based architecture associated with a smart home or network provider, which has associated network resources hosted on the internet or private network (e.g., network 104), which enables (via topology engine 200) the device control and management discussed herein.

In some embodiments, cloud system 106 may include a server(s) and/or a database of information which is accessible over network 104. In some embodiments, a database of cloud system 106 may store a dataset of data and metadata associated with local and/or network information related to a user(s) of the components of system 100 and/or each of the components of system 100 (e.g., UE 102, AP device 108, and the services and applications provided by cloud system 106 and/or topology engine 200).

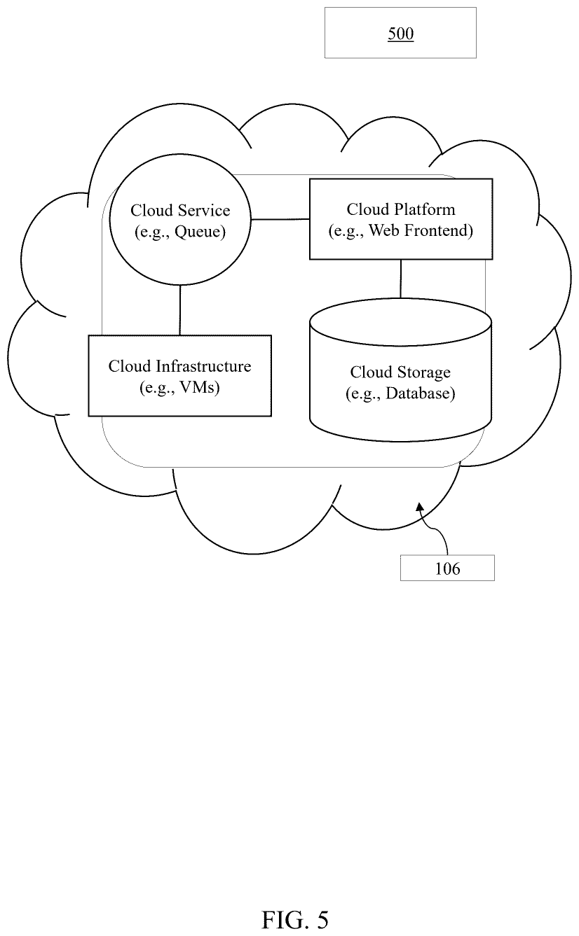

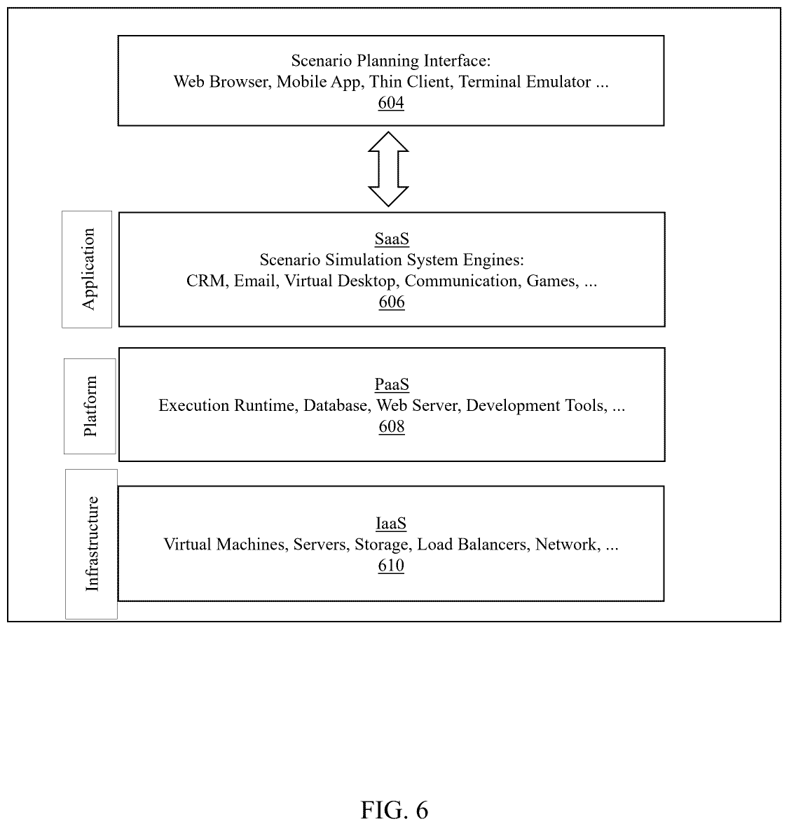

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture such as, but not limiting to: infrastructure as a service (IaaS) 610, platform as a service (PaaS) 608, and/or software as a service (SaaS) 606 using a web browser, mobile app, thin client, terminal emulator or other endpoint 604. FIGS. 5 and 6 illustrate schematics of non-limiting implementations of the cloud computing/architecture(s) in which the exemplary computer-based systems for administrative customizations and control of network-hosted application program interfaces (APIs) of the present disclosure may be specifically configured to operate.

In some embodiments, the framework includes a database to receive storage instructions/requests from, for example, topology engine 200 (and associated microservices), which may be in any type of known or to be known format, such as, for example, standard query language (SQL). According to some embodiments, the database may correspond to any type of known or to be known storage, for example, a memory or memory stack of a device, a distributed ledger of a distributed network (e.g., blockchain, for example), a look-up table (LUT), and/or any other type of secure data repository.

Topology engine 200, as discussed above and further below in more detail, can include components for the disclosed functionality. According to some embodiments, topology engine 200 may be a special purpose computing machine or processor, and can be hosted by a device on network 104, within cloud system 106, on AP device, 108 and/or on UE 102. In some embodiments, topology engine 200 may be hosted by a server and/or set of servers associated with cloud system 106.

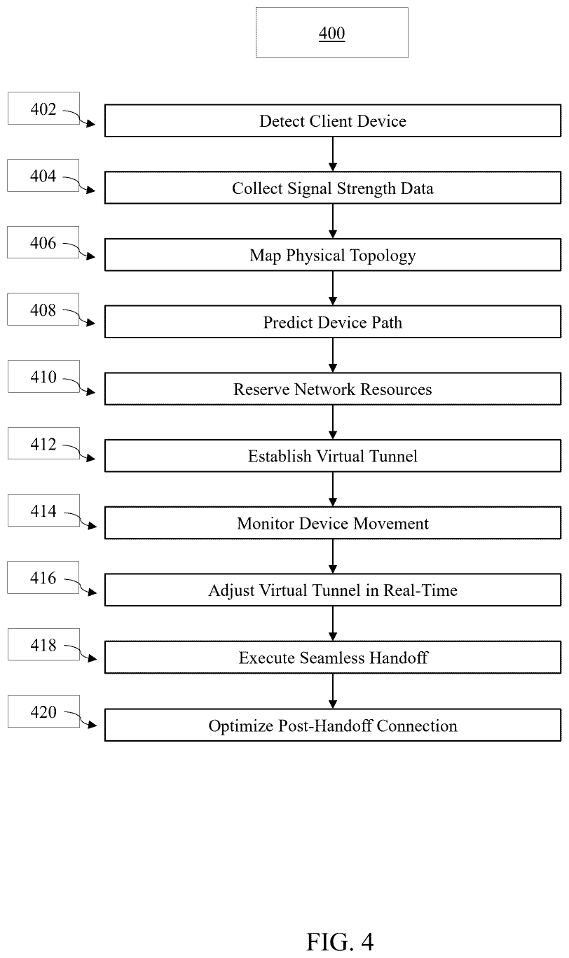

According to some embodiments, as discussed in more detail below, topology engine 200 may be configured to implement and/or control a plurality of services and/or microservices, where each of the plurality of services/microservices are configured to execute a plurality of workflows associated with performing the disclosed application control and management framework. Non-limiting embodiments of such workflows are provided below in relation to at least FIG. 4.

According to some embodiments, as discussed above, topology engine 200 may function as an application provided by cloud system 106. In some embodiments, topology engine 200 may function as an application installed on a server(s), network location and/or other type of network resource associated with system 106. In some embodiments, topology engine 200 may function as an application installed and/or executing on UE 102 (and/or AP device(s) 108, in some embodiments). In some embodiments, such an application may be a web-based application accessed by AP device 108 and/or UE over network 104 from cloud system 106. In some embodiments, topology engine 200 may be configured and/or installed as an augmenting script, program or application (e.g., a plug-in or extension) to another application or program provided by cloud system 106 and/or executing on AP device 108 and/or UE 102.

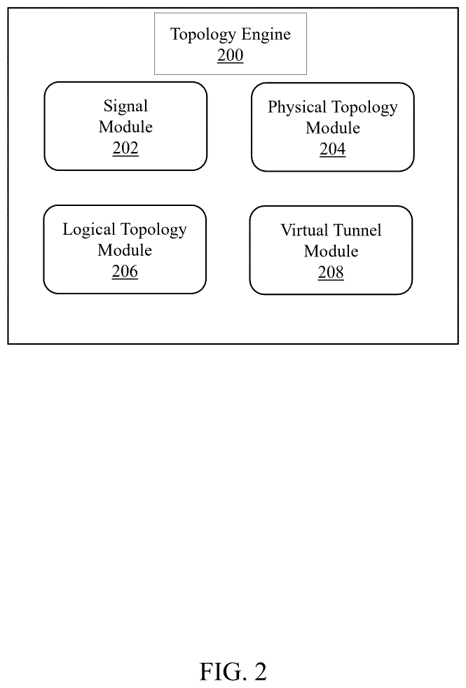

As illustrated in FIG. 2, according to some embodiments, topology engine 200 includes one or more of a signal module 202, a physical topology module 204, a network topology module 206, and virtual tunnel module 208. It should be understood that the engine(s) and modules discussed herein are non-exhaustive, as additional or fewer engines and/or modules (or sub-modules) may be applicable to the embodiments of the framework and methods discussed. More detail of the operations, configurations and functionalities of topology engine 200 and each of its modules, and their role within embodiments of the present disclosure will be discussed below.

In some embodiments, the signal module 202 is configured to identify the APs used by the framework in various ways. For example, in some embodiments, the signal module 202 can identify individual APs by scanning for unique Media Access Control (MAC) addresses and/or Internet Protocol (IP) addresses. Some embodiments described herein identify APs by scanning for Service Set Identifiers (SSIDs), which provides the name of the network.

In some embodiments, the signal module 202 uses Radio Resource Management (RRM) to ensure optimal distribution of available radio frequency (RF) spectrum among multiple access points (APs) in a network. The RMM includes functionality that manages and controls various parameters of a wireless network such as transmit power, channel allocation, data rates, as several signal control examples. In some embodiments, the RRM is configured to dynamically assign channels to APs based on the current network conditions which helps to minimize interference and optimize network performance. In some embodiments, the RRM is configured to adjust the transmit power of APs to ensure adequate coverage while minimizing interference. For example, if two APs are too close to each other, the RRM, via the signal module 202, is able to (i.e., configured to) reduce their transmit power to avoid interference. The RRM can also distribute network traffic evenly across multiple APs to prevent any single AP from becoming a bottleneck, which is useful in high-density environments where many devices are connected to the network. In some embodiments, the RRM can identify areas with weak or no signal (known as “coverage holes”) and adjust the network parameters to improve coverage in these areas. This might involve increasing the transmit power of nearby APs or changing their channel assignment, which can be done proactively (i.e., before a user arrives) once a virtual tunnel is established as further described herein.

Still referring to FIG. 2, in some embodiments, the physical topology module 204 is configured to use physical locations of the APs and/or a physical layout of an MDU to predict a path the client device will travel. The physical location of the APs can be determined in one or more ways. In some embodiments, the physical topology module 204 is configured to use an AP map, which may include a digital representation of the MDU structure (e.g., walls, floors, levels, etc.) and/or the location of the APs within the MDU. Suitable digital representations of an MDU include blueprints, CAD drawings, and/or a signal strength map.

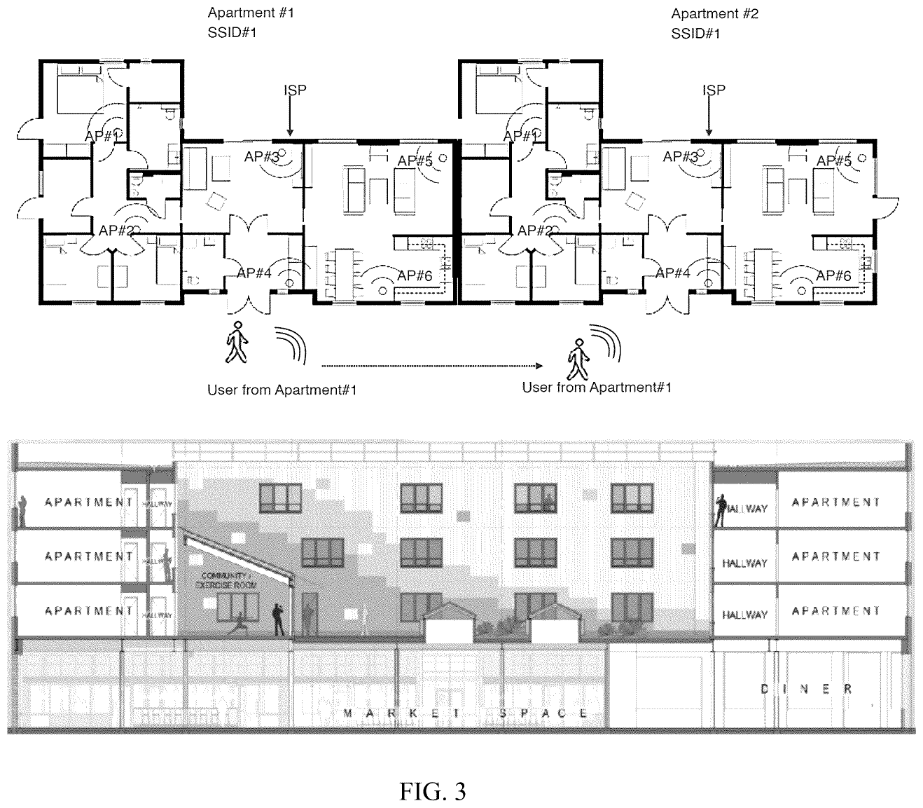

Referring now to FIG. 3, in some embodiments, the physical topology module 204 is configured to use signal strength of one or more APs to generate a signal strength map. For example, a first unit in an MDU has a first AP in a bedroom (AP #1), a second AP in a bathroom (AP #2), a third AP in a living room (AP #3), while a second unit below (and/or above) the first unit has a fourth AP. Each AP in the first unit is separated by walls, reducing their signal strength. As the client device moves to a doorway linking the bedroom and living room, the third AP signal increases suddenly, which the physical topology module 204 records.

Likewise, as the person goes into the living room, the first signal decreases suddenly while the third signal stays elevated, which is also recorded in a database. A similar scenario unfolds as the client device enters the bathroom. Using the change in signals, including sudden increases and/or drops from the signal of one or more APs, the physical topology module 204 is configured to map one or more walls within a unit and/or MDU. Advantageously, the physical topology module 204 is able to distinguish openings as paths (e.g., FIG. 3: doors) or non-paths (e.g., FIG. 3: windows) by storing a user's motion patterns, where movement through or past an opening, such as when traveling from one apartment to the next, is defined as a path or non-path, respectively.

Additionally, the fourth AP in the second unit also provides input to the physical topology module 204. As the floor is continuous in the first unit, the proportional signal change (i.e., not sudden) as the use moves within the first unit indicates a solid structure, which is interpreted as a floor (or ceiling from above). In some embodiments, the framework is connected to a plurality (e.g., all) APs within an MDU, and can receive signals from one or more APs simultaneously, where a history of signal changes and/or movement defines paths, non-paths, stairs, and/or obstacles within the MDU. A non-limiting example MDU is shown in FIG. 3.

In some embodiments, the physical topology 204 module uses a Global Positioning System (GPS), which may be associated with UE 102, to determine physical topology, where the movement is received and/or stored by the physical topology module to define the paths, non-paths, and/or obstacles.

Referring back to FIG. 2, with the MDU at least partially mapped by the physical topology module, the logical topology module 206 is configured to predict a client device (and user) path. In some embodiments, the prediction is based on historical signal strength data obtained by the physical topology module 204 and stored in a database. In some embodiments, when a device moves away from one AP and towards another, the framework is configured to initiate a handoff before the connection quality degrades to an unusable point. This includes disconnecting the device from the first AP and connecting it to the second AP, where the logical topology module 206 determines the path that the data packets from the client device take during this handoff. Additionally, the logical topology module 206 might use load balancing to distribute network traffic evenly across all APs, or band steering to direct devices to the most appropriate frequency band (2.4 GHz or 5 GHz) based on their capabilities and the current network conditions.

In some embodiments, the logical topology module 206 is configured to skip a connection to one or more APs along a path. Instead of basing a connection solely on signal strength, the logical topology module 206 is configured to predict, using historical information from one or more modules, which APs will be used as the client moves through a space. In some embodiments, the logical topology module 206 is configured to use historical signal strength and/or AP signal strength adjustment capabilities to determine sufficient overlap in signal strength between a first AP and a second AP to initiate a handoff. In some embodiments, at least a portion of a third AP signal overlaps one or more of the first AP signal and the second AP signal, where the logical topology module 206 is configured to skip the third AP signal intentionally, regardless of signal strength.

When the device moves out of the range of the first AP and into the range of a second AP, it disconnects from the first AP and connects to the second one. This process, or “handoff”, can cause a temporary interruption in the network connection, leading to buffering or lagging in data transmission. This is mitigated by skipping APs. However, to enhance connectivity performance even more, in some embodiments, the framework includes a virtual tunnel module 208.

In some embodiments, the virtual tunnel module 208 is configured to execute a seamless handoff for client devices as they move through the network in a Multi-Dwelling Unit (MDU). In some embodiments, a seamless handoff includes the client device transitioning from one access point (AP) to another without the user experiencing any substantial interruption in service, such as dropped connections and/or buffering. The virtual tunnel module works in conjunction with the physical topology module 204 and logical topology module 206 to predict the path a client device will take based on historical data and the physical layout of the MDU. This prediction includes identifying which APs the device will likely connect to as it moves as described above. Once the path is predicted, the virtual tunnel module 208 can reserve resources on the APs along the predicted path. This reservation ensures that the necessary bandwidth and connection capabilities are available for the client device when it reaches the new AP's coverage area.

In some embodiments, the virtual tunnel module 208 is configured to pre-emptively prepare the APs for the handoff by establishing a virtual tunnel. In some embodiments, the virtual tunnel acts as a bridge between the current AP and the next AP in the predicted path, allowing for quick and efficient transfer of the client device's connection. As the client device moves, the virtual tunnel module continuously monitors the signal strength and connection quality. If the actual path deviates from the predicted path, the virtual tunnel module 208 can adjust the virtual tunnel in real-time to accommodate the device's new trajectory.

When the client device approaches the boundary of the current AP's coverage area, the virtual tunnel ensures that the handoff to the next AP is executed seamlessly. In some embodiments, the device's connection is transferred to the new AP via the virtual tunnel without the need for re-authentication or re-association, which are common causes of handoff delays. After the handoff, the virtual tunnel module can optimize the device's connection settings with the new AP to ensure the best possible performance. This may involve adjusting transmit power, channel selection, or other RRM parameters as discussed above.

In some embodiments, the virtual tunnel enables direct connection/handoff between APs, and in some embodiments, the virtual tunnel is formed over the network with a cloud (or cloud resource), whereby the connection to a second AP can be effectuated via the tunnel from the first AP to a second AP.

By way of a non-limiting example, a UE is connected to AP 1 at a location. When UE moves to a location where the network connectivity is stronger from AP 2, for example, a virtual tunnel can be created. Here, for example, AP 2 is a neighbor's router. Thus, as discussed herein, the disclosed framework can cause a virtual tunnel, via cloud system 106, to be created from AP 1 to AP 2, which enables UE to connect to and leverage the network capabilities provided by AP 2.

Turning to FIG. 4, Process 400 is a flowchart representation of steps executed by the framework according to the non-limited example described herein. The steps described in FIG. 4 as well as throughout this disclosure represent both an execution of a computer algorithm and a method of implementing the framework.

According to some embodiments, Steps 402-404 of Process 400 can be performed by signal module 202 of topology engine 200; Step 406 can be performed by physical topology module 204; Step 408 can be performed by logical topology module 206; and Steps 410-420 can be performed by virtual tunnel module 208.

According to some embodiments, Process 400 begins with Step 402 where the signal module 202 identifies the presence of a client device (UE 102) within the network. In some embodiments, at Step 404, the signal module 202 collects signal strength measurements from multiple APs to determine the client device's proximity to each AP. Such determination can be performed via a computational analysis, as discussed below. At Step 406, the physical topology module 204 uses the signal strength data to map the physical layout of the MDU, identifying walls, floors, and potential paths. Based on historical signal strength data and the physical layout, the logical topology module 206 predicts the path the client device will likely take through the MDU at Step 408.

At Step 410, the virtual tunnel module 208 reserves bandwidth and connection capabilities on the APs along the predicted path of the client device. In some embodiments, at Step 412, the virtual tunnel module 208 sets up a virtual tunnel between the current AP and the next AP on the predicted path, preparing for the client device's handoff. As the client device moves, the virtual tunnel module 208 continuously, periodically, and/or intermittently monitors its signal strength and connection quality at Step 414. If the client device deviates from the predicted path, at Step 416 the virtual tunnel module 208 adjusts the virtual tunnel accordingly. When the client device approaches the coverage boundary of the current AP, the framework seamlessly transitions the connection to the next AP via the virtual tunnel at Step 418 in accordance with some embodiments. In some embodiments, after the handoff, in Step 420 the framework optimizes the connection settings with the new AP to ensure continued optimal performance.

In some embodiments, the computational analysis discussed above respective to Process 400 (e.g., Steps 406-420, for example), can involve topology engine 200 executing any type of known or to be known computational analysis technique, algorithm, mechanism or technology. In some embodiments, topology engine 200 may include a one or more artificial intelligence/machine learning (AI/ML) models to execute various aspects of the framework, where various portions of the framework are processed using a particular machine learning model architecture, a particular machine learning model type (e.g., convolutional neural network (CNN), recurrent neural network (RNN), autoencoder, support vector machine (SVM), and the like), or any other suitable algorithm or combination of techniques described herein.

In some embodiments, topology engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model for the control framework,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained AI model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained AI model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

FIG. 7 is a schematic diagram illustrating a client device showing an example embodiment of a client device that may be used within the present disclosure and/or the framework illustrated in FIG. 1. Client device 700 may include many more or less components than those shown in FIG. 7, such as a plurality of computers. However, the components shown are sufficient to disclose an illustrative embodiment for implementing the present disclosure. Client device 700 may represent, for example, UE 102 discussed above at least in relation to FIG. 1.

As shown in the figure, in some embodiments, client device 700 includes one or more processors (CPU) 722 in communication with one or more non-transitory computer readable media 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external devices. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device 700 may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules, usage data, or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more databases, which can be utilized by Client device 700 to store, among other things, applications 742 and/or other information or data. For example, databases may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with topology engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:
Aspect 1. A method comprising:
   receiving, over a network, data related to a physical layout of a network environment;
   identifying locations of a plurality of wireless access points (APs) within the network environment;
   analyzing data indicating a location and movement of a client device within the network environment, the client device initially connected to a first AP of the plurality of APs;
   predicting a movement path of the client device based on the location and movement analysis, the predicted movement path comprising information indicating a past position of the client device, a current position and a route from the path position to the current position;
   determining, based on the movement path and the identified locations of the APs, a second AP; and
   causing, based on the current position of the client device, a handoff of a network connection from the first AP to the second AP.
Aspect 2. The method of aspect 1, further comprising:
   creating a virtual tunnel on the network, the virtual tunnel comprising a connection between the first AP and the second AP, wherein the handoff occurs via the connection.
Aspect 3. The method of aspect 2, wherein the virtual tunnel comprises a cloud resource, wherein the cloud resource is an intermediary within the connection between the first AP and the second AP.
Aspect 4. The method aspect 2, wherein the creation of the virtual tunnel further comprises establishing a pre-configured pathway for data packets to travel between a first AP and a second AP, wherein the virtual tunnel is configured to reduce latency during the handoff.
Aspect 5. The method of aspect 1, further comprising:
   tracking the movement of the client device, wherein the movement tracking continues upon the handoff to the second AP.
Aspect 6. The method of aspect 1, further comprising:
   reserving network resources at the second AP in anticipation of the client device's movement, wherein the reserved network resources are enabled for usage by the client device upon the handoff.
Aspect 7. The method of aspect 6, further comprising:
   monitoring the client device's movement; and
   adjusting, based on data collected during the monitoring, the reserved network resources in near real-time.
Aspect 8. The method of aspect 1, wherein the network environment includes a Multi-Dwelling Unit (MDU) comprising multiple floors and units, and the plurality of APs are distributed at least throughout the MDU to provide wireless coverage.
Aspect 9. The method of aspect 1, wherein the prediction of the movement path of the client devices is further based on historical connection data and user behavior patterns.

As used herein, the terms “computer engine” and “engine” identify at least one software component and/or a combination of at least one software component and at least one hardware component, which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module includes software, hardware, or firmware (or combinations thereof), process or functionality, or component thereof, that performs or facilitates the processes, features, and/or functions described herein (with or without human interaction or augmentation). A module can include sub-modules. Software components of a module may be stored on a non-transitory computer readable medium for execution by a processor. Modules may be integral to one or more servers or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user,” “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, over a network, data related to a physical layout of a network environment;
identifying locations of a plurality of wireless access points (APs) within the network environment;
analyzing data indicating a location and movement of a client device within the network environment, the client device initially connected to a first AP of the plurality of APs;
predicting a movement path of the client device based on the location and movement analysis, the predicted movement path comprising information indicating a past position of the client device, a current position and a route from the path position to the current position;
determining, based on the movement path and the identified locations of the APs, a second AP; and
causing, based on the current position of the client device, a handoff of a network connection from the first AP to the second AP.

2. The method of claim 1, further comprising:
creating a virtual tunnel on the network, the virtual tunnel comprising a connection between the first AP and the second AP, wherein the handoff occurs via the connection.

3. The method of claim 2, wherein the virtual tunnel comprises a cloud resource, wherein the cloud resource is an intermediary within the connection between the first AP and the second AP.

4. The method claim 2, wherein the creation of the virtual tunnel further comprises establishing a pre-configured pathway for data packets to travel between a first AP and a second AP, wherein the virtual tunnel is configured to reduce latency during the handoff.

5. The method of claim 1, further comprising:
tracking the movement of the client device, wherein the movement tracking continues upon the handoff to the second AP.

6. The method of claim 1, further comprising:
reserving network resources at the second AP in anticipation of the client device's movement, wherein the reserved network resources are enabled for usage by the client device upon the handoff.

7. The method of claim 6, further comprising:
monitoring the client device's movement; and
adjusting, based on data collected during the monitoring, the reserved network resources in near real-time.

8. The method of claim 1, wherein the network environment includes a Multi-Dwelling Unit (MDU) comprising multiple floors and units, and the plurality of APs are distributed at least throughout the MDU to provide wireless coverage.

9. The method of claim 1, wherein the prediction of the movement path of the client devices is further based on historical connection data and user behavior patterns.

10. A system comprising:
a processor configured to:
receive, over a network, data related to a physical layout of a network environment;
identify locations of a plurality of wireless access points (APs) within the network environment;
analyze data indicating a location and movement of a client device within the network environment, the client device initially connected to a first AP of the plurality of APs;
predict a movement path of the client device based on the location and movement analysis, the predicted movement path comprising information indicating a past position of the client device, a current position and a route from the path position to the current position;
determine, based on the movement path and the identified locations of the APs, a second AP; and
cause, based on the current position of the client device, a handoff of a network connection from the first AP to the second AP.

11. The system of claim 10, wherein the processor is further configured to:
create a virtual tunnel on the network, the virtual tunnel comprising a connection between the first AP and the second AP, wherein the handoff occurs via the connection.

12. The system of claim 11, wherein the virtual tunnel comprises a cloud resource, wherein the cloud resource is an intermediary within the connection between the first AP and the second AP.

13. The system claim 11, wherein the processor is further configured to:
establish a pre-configured pathway for data packets to travel between a first AP and a second AP, wherein the virtual tunnel is configured to reduce latency during the handoff.

14. The system of claim 10, wherein the processor is further configured to:
track the movement of the client device, wherein the movement tracking continues upon the handoff to the second AP.

15. The system of claim 10, further comprising:
reserve network resources at the second AP in anticipation of the client device's movement, wherein the reserved network resources are enabled for usage by the client device upon the handoff.

16. The system of claim 15, wherein the processor is further configured to:
monitor the client device's movement; and
adjust, based on data collected during the monitoring, the reserved network resources in near real-time.

17. The system of claim 10, wherein the network environment includes a Multi-Dwelling Unit (MDU) comprising multiple floors and units, and the plurality of APs are distributed at least throughout the MDU to provide wireless coverage.

18. The system of claim 10, wherein the prediction of the movement path of the client devices is further based on historical connection data and user behavior patterns.

19. A non-transitory computer-readable storage medium tangibly encoded with computer-executable instructions, that when executed by a processor, perform a method comprising:
receiving, over a network, data related to a physical layout of a network environment;
identifying locations of a plurality of wireless access points (APs) within the network environment;
analyzing data indicating a location and movement of a client device within the network environment, the client device initially connected to a first AP of the plurality of APs;
predicting a movement path of the client device based on the location and movement analysis, the predicted movement path comprising information indicating a past position of the client device, a current position and a route from the path position to the current position;
determining, based on the movement path and the identified locations of the APs, a second AP; and
causing, based on the current position of the client device, a handoff of a network connection from the first AP to the second AP.

20. The non-transitory computer-readable storage medium of claim 19, further comprising:
creating a virtual tunnel on the network, the virtual tunnel comprising a connection between the first AP and the second AP, wherein the handoff occurs via the connection, wherein the virtual tunnel comprises a cloud resource, wherein the cloud resource is an intermediary within the connection between the first AP and the second AP.
